(19) United States
(12) Patent Application Publication
(10) Pub. No.: US 2012/0170293 A1
(43) Pub. Date: Jul. 5, 2012

(54) Multi-tower work station

(76) Inventor: Matthew Terry, Denver, CO (US)

(21) Appl. No.: 12/930,370

(22) Filed: Jan. 5, 2011

(51) Int. Cl. F21S 8/00; F16L 3/08; F16B 2/02; F16M 11/04

(52) U.S. Cl. 362/431; 248/158; 248/74.1

(57) ABSTRACT

A linear arrangement comprising a pole having at least one adjustable arm for storing and using devices in a utility space, such as workspaces for home entertainment, accessory storage, for use by automotive mechanics, artists, seamstresses, beauticians, aestheticians, doctors, dentists, manicurists, cosmetologists, jewelers, musicians, or anyone requiring easy access to a multiplicity of work areas and equipment is provided. The present invention could also be used for display purposes in a retail setting, or for storage. It could also be used as a host stand in a restaurant, or in a kitchen for holding a multiplicity of appliances.

### CLAIM OF PRIORITY

This patent application claims priority under 35 USC 120 from U.S. Regular patent application Ser. No. 11/820,076, filed Jun. 18, 2007, of common inventorship herewith entitled, “Multi-Functional Linear Utility Station.”

### FIELD OF INVENTION

This invention relates to the field of utility spaces. Specifically this invention relates to a linear arrangement for storing and using devices in a utility station, such as workspaces for home entertainment, accessory storage, for use by automotive mechanics, artists, seamstresses, beauticians, aestheticians, or anyone requiring easy access to a multiplicity of work areas and equipment. It is also useful for storage or display of a variety of components. The linear utility station of the present invention can be utilized in any orientation such as vertical, horizontal or any angle in between vertical and horizontal, according to the needs of the user.

### BACKGROUND OF THE INVENTION

The utility or work station, or desk as it was previously known, is an integral part of most people's homes. Over the years, devices such as computers and all their accessories and peripherals have added considerable requirements to the desk from a simple table to an accessory storage system, a.k.a. utility station. Depending on how many accessories you wish to have, these utility stations can be considerable in size. In addition, there are ergonomic concerns due to the time spent at these utility stations, using keyboards and sitting in chairs for longer periods of time. Therefore, inventors have created several solutions to make the utility stations more adjustable to the specific user, while keeping the utility station footprint or area required as small as possible.

US patent to Bollman, U.S. Pat. No. 4,705,327 discloses a multi adjustable multi functional work station system. This system appears to use a plurality of work surfaces and therefore has a considerable footprint.

US patent to Schwartz, U.S. Pat. No. 4,987,835 discloses an automatic vertically adjustable work surface. This system appears to attach a work surface to a wall and does not consider the other components to a modern utility station such as a computer or monitor.

US patent to Maguire, U.S. Pat. No. 5,416,666 shows an ergonomic operator utility station having a monitor with wing unit. This system appears to have a considerable footprint and does not appear to be adaptable to any new accessory that the user may wish to add at a later date.

US patent to Richard, U.S. Pat. No. 5,522,323 shows an ergonomic computer utility station that appears to use a desk configuration and therefore a considerable footprint. In addition, it appears to lack adaptability to any new accessory or component that may come in the future.

US patent to Sweere, U.S. Pat. No. 6,189,849 discloses a lift system for a monitor and keyboard that attaches to the wall. This is specifically for the lift system and does not consider other utility station components.

US patent publication to Johnson, Publication number 2006/0054751 includes a vertically adjustable mobile computer utility station that appears to be a cart system to carry and store a computer, monitor and keyboard. It does not consider any other accessories. The keyboard and monitor may also not be adjustable relative to each other.

US patent to Weener, U.S. Pat. No. 5,913,783 discloses a portable multipurpose floor ceiling pole for an office. This pole appears to be a telescopic support pole for offices with clamps or brackets for office furniture.

### SUMMARY OF THE INVENTION

The present invention provides improvements over these previous designs by providing a more comprehensive utility station, capable of managing many electronic components or accessories, using minimal space and with maximum ergonomic potential. Electronic components are defined as modern technology elements such as computer components, including monitors, key boards, scanners, fax machines, “x-box” consoles, “m-box” consoles, “Ipod” or Mp3 accessories as well as speakers, lamps and work space, for example.

Specifically, this invention relates to a linear arrangement for storing and using devices in a utility space, such as workspaces for home entertainment, accessory storage, for use by automotive mechanics, artists, seamstresses, beauticians, aestheticians, doctors, dentists, manicurists, cosmetologists, jewelers, musicians, or anyone requiring easy access to a multiplicity of work areas and equipment. The present invention could also be used for display purposes in a retail setting, or for storage. It could also be used as a host stand in a restaurant, or in a kitchen for holding a multiplicity of appliances.

In many home, commercial and office environments, abundant space is not always available, especially for the ever growing number of components and accessories that can be part of a utility station, such as speakers, camera printers and multiple monitors. This invention provides a method of managing these components at positions convenient to the user while minimizing the amount of space required. The present invention facilitates the use of a single work station by multiple users, such as shift workers. The instant invention is also useful in dorm rooms or loft homes, which have a minimum of space.

In addition to spatial constraints, wiring for the growing number of components is also a consideration. Many utility stations require at least one, and often more than one power strip to accommodate all of the components. The present invention provides a means for accommodating a multiplicity of wiring and communications cables together with an integrated electrical power strip to conveniently, safely and neatly provide access for all components. Such wiring for components may include, for example an Ethernet jack, phone jack, or other network and connectivity components, and electrification for lighting or other components.

This utility station is intended to be easily moved or repositioned when necessary. The arms of the invention can then be folded and the unit moved to a corner when not in use, providing the user with more space when required.

The individual accessories and components may be repositioned to the user's benefit using a variety of hinges and joints. The joints may be of a variety of configurations including elbow joints and block joints, for example. The joints may be locking joints. Any joints for permitting the movement and stabilization of the various platforms of the work station are envisioned. The present invention provides improved ergonomics over many existing utility stations.

The accessories or components could easily be repositioned when not in use. This invention could therefore take up less space when not in use.

Furniture such as lap tables, shelving or filing cabinets could be attached to this utility station also if necessary to add utility.

Any number of arms can be added to the utility station pole to add utility and maximize space efficiency.

The utility station of the present invention provides many advantages over the existing utility station designs. It is flexible and able to adapt to the changing technology world. It takes up minimal space and will accommodate a wide range of ergonomic requirements and can be repositioned for multiple users.

One embodiment of the invention comprises a table top having a hole in the middle to accommodate the vertical pole, for use by a multiplicity of users simultaneously with or without seating for these users situated on a multiplicity of arms.

The components of the present invention can be made from a variety of materials including, but not limited to: wood, aluminum, graphite, plastic, alloys, other metals and thermoplastic materials and composite materials, for example.

### BRIEF DESCRIPTION OF THE DRAWINGS

FIG. 1 shows a perspective view of the linear utility station of the present invention in a vertical orientation.

FIG. 2 shows an embodiment of the present invention illustrating a base fixture.

FIG. 3a shows one embodiment of the pole base's configuration.

FIG. 3b shows an alternative embodiment of the pole base's configuration.

FIG. 4 shows an embodiment of a wall fixture mechanism.

FIG. 5 shows a side view of the accessory attachment means.

FIG. 6 shows an embodiment of the arm hinge means.

FIG. 7 shows a top view of an embodiment of the accessory collar positioning means.

FIG. 8 shows an embodiment of a block joint.

FIG. 9 shows an alternative embodiment shown an alternative base and additional retention system.

FIG. 10 shows the top view of a work space component having a hole near the corner to accommodate the vertical column.

FIG. 11 shows the top and side views of a semi-circular horizontal work space component having a hole to accommodate the vertical column.

FIG. 12 shows the top view of a horizontal work space component having a semi-circular cut out for access by the user and a hole near the center to accommodate the vertical column.

FIG. 13 shows the top view of a horizontal work space component having a quarter circular cut out and a hole near one end to accommodate the vertical column.

FIG. 14 shows a top view of a snap punch locking vertical collar for encircling and attaching an arm to the vertical column.

FIG. 15 shows a top view of a hex key locking vertical collar for encircling and attaching an arm to the vertical column.

FIG. 16 is s side view of the chrome steel vertical column.

FIG. 17 shows a top view of a horizontal work space component showing a corner component having two sides and a hole near the center to accommodate the vertical column.

FIG. 18 shows the top view of a horizontal work space component having a semi-circular cut out for access by the user and a hole near one corner to accommodate the vertical column.

FIG. 19 shows a top view of a support platform base for supporting equipment and also showing a hole near the center to accommodate the vertical column.

FIG. 20 shows the stepped ring column base. FIG. 20a is a top view thereof and FIG. 20b is a side view thereof.

FIG. 21 shows the sloped top column base. FIG. 21a is a top view thereof and FIG. 21b is a side view thereof.

FIG. 22 is a top schematic view of an articulating foot rest showing a hole to accommodate the vertical column.

FIG. 23 is a top view of a horizontal collar for attaching to a horizontal work space component.

FIG. 24 is a side view of the horizontal collar of FIG. 23.

FIG. 25 is a top perspective view of a component horizontal collar for attaching the horizontal work space component to the vertical column.

FIG. 26 is a side view of the collar of FIG. 25.

### DETAILED DESCRIPTION

The Multi Tower (hereinafter MT) is a space saving, ergonomic, environmentally friendly invention. The MT is a single column positioned on a large stable base, with multiple arms that can be rearranged “on demand”. “On demand” or “user responsive” arms are exclusive to the MT design. The user can easily readjust each arm within a few moments. Each arm can pivot or swivel on the main column, and the vertical height can be adjusted. The on demand feature enables the user to readjust their personal workspace or adjust to multiple users. This allows the user to work on multiple projects with out unnecessary movement. This feature also prevents repetitive motion injuries as it allows the user to customize the MT to a specific task. The ergonomic setup of the MT will improve productivity by allowing a fatigued user to rearrange their working position. The MT has the ability to be produced from a variety of recycled materials specifically aircraft aluminum.

The arms are arranged in a linear manner, and can fully maximize the overall space of the MT footprint. One MT takes up around 12 square feet while providing three times the amount of workable space as a traditional piece of furniture. The MT can easily fit into any corner of any room or office taking up the least amount of desired open floor space.

Other features included in the MT design are cable holders for neatly tucking away device cables with built in power supply at the top middle and bottom of MT's; it also includes removable bookends, extendable arms, USB and fire wire cable-positioning centers. File drawers or dividers and retractable wheels for easy moving add to its convenience. In an alternative embodiment, electromagnetic shields to minimize EMF pollution are added. Some of these features are specific to the office environment.

The design capability can be applied in multiple fields, including, but not limited to, pc and Xbox gamers, restaurants for kitchen prep, host stands, server stations, retail displays, check out stands, basic dorm rooms, cubicle desks, garages, hospital rooms, medical labs, treatment rooms, cosmetic counters, salons and music studios. There are also smaller versions useful for entry tables in homes, easy home organization, outdoor garden areas and patios; a modified version having capability of use by disabled persons is also contemplated. Depending on the application, the production material, size and some of the added features will change to fit use requirements such as mirrors, cutting boards, microphones etcetera.

As used herein, the term “work station” and “utility station” are to be construed as meaning the same thing. Also, even though most of the following description is directed toward a vertical utility station.

As used herein, the term “column” and “pole” are to be construed as meaning the same thing.

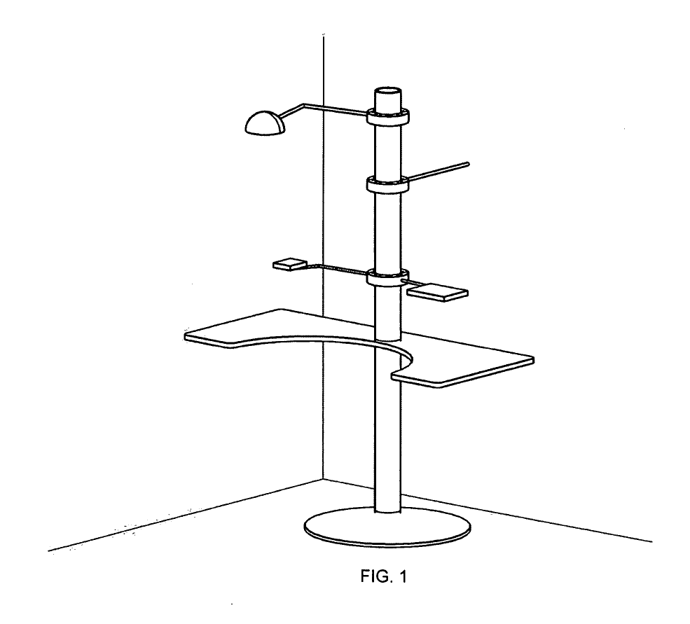

FIG. 1 is a perspective view of the invention of the present invention showing the vertical utility station and some possible components.

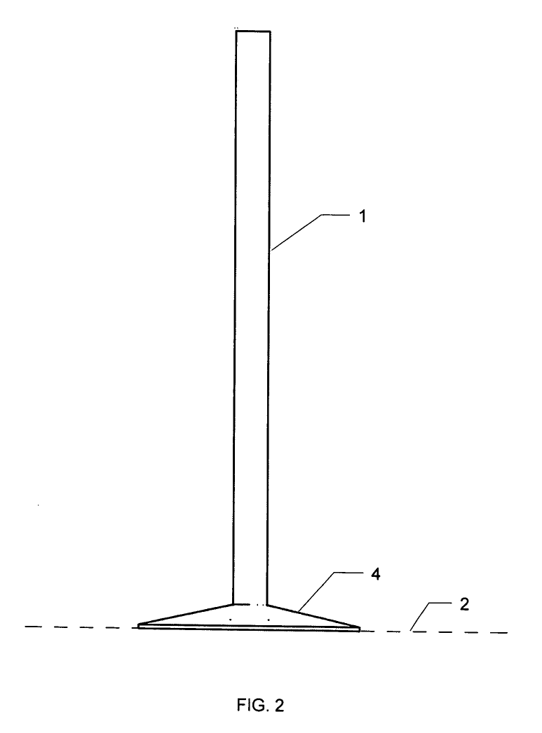

FIG. 2 shows one possible embodiment of the vertical workspace support pole 1. Pole 1 consists of a tube that may be circular in cross section. The cross-section of pole 1 may also be other shapes if necessary for structural requirements or aesthetics, such as rectangular, square, triangular, oval, elliptical, or other shape. The pole 1 is made from a significantly structurally supportive material, such as steel or aluminum, for example, so as to support the weight of the components or accessories that will be attached to pole 1. Pole 1 may be a solid tube or hollow. In one preferred embodiment, the pole 1 is at least partially hollow so as to accommodate wiring connections including but not limited to electrical power, USB, cable, speaker wire or internet connections, for example.

FIG. 2 shows the pole 1 spanning from the floor to some desired height, but does not necessarily touch the ceiling 3. At the bottom of the pole 1 there is a pole base 4. Base 4 can be equipped with wheels (not shown) for ease of relocation. The wheels can be locking wheels to provide stability when the pole is in its new location.

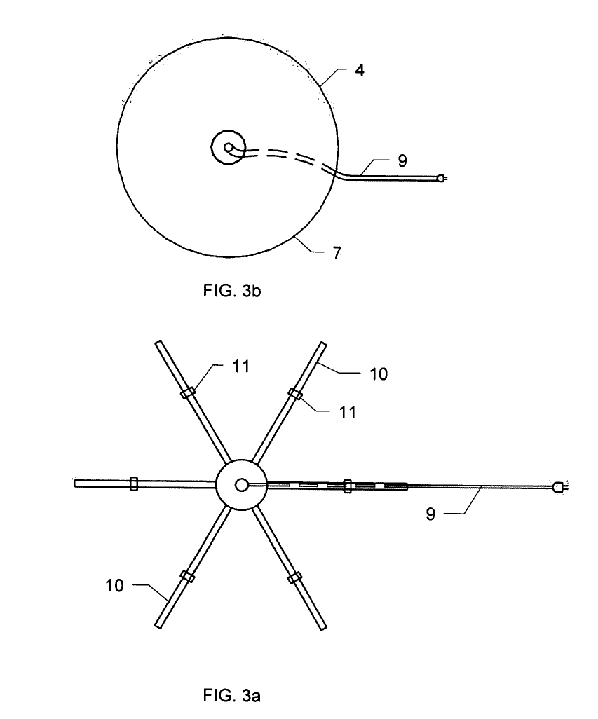

FIG. 3a shows a top view of an embodiment for the pole base 4. In FIG. 3a, the perimeter 7 is large enough to stabilize the pole when components are added to the utility station. The pole base 4 may be filled with a material to help stabilization such as water or sand. There may be a wiring connection 9 that electrically connects the accessories on the pole 1 to a wall socket. This wiring connection could include but is not limited to a USB connection, electrical connection and speaker wiring.

FIG. 3b shows a top view of another embodiment for the pole base 4. The base 4 of this embodiment consists of a plurality of stabilizing, extendable and contractible legs 10. These legs 10 are independently telescopic via mechanical means such as screw or sliding means. A positioning collar 11 may also be used to fix the legs 10 in position. This collar 11 can be loosened by twisting the collar 11 in one direction to allow the leg 10 to extend or contract. By twisting the collar 11 in the opposite direction to tighten the collar 11, the leg 10 may be fixed in the desired position. By varying each leg length the utility station stability can be optimized for varying weights and sizes of accessory.

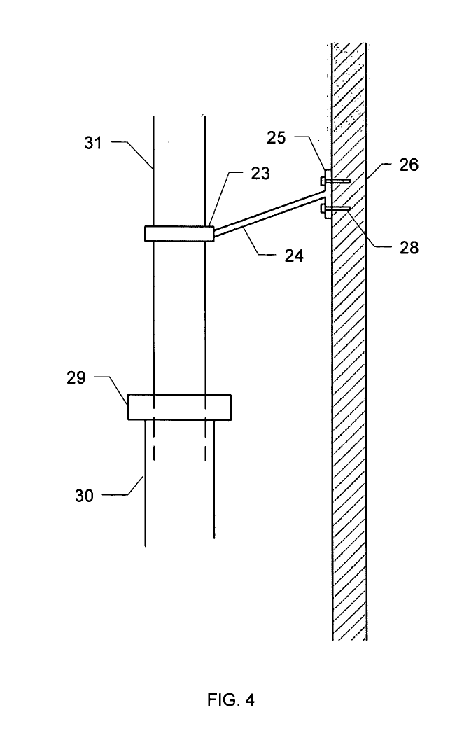

FIG. 4 shows a pole 1 which is attached to a wall 26. In this embodiment pole 1 is split into two poles, the upper pole 31 and lower pole 30. The desired height can be achieved using the pole tightening collar 29. The tightening collar 29 can be loosened by twisting the collar 29 in one direction and then sliding the upper pole 31 and lower pole 30 relative to each other to the desired overall height. Then the tightening collar 29 can be twisted in the opposite direction to tighten the collar 29 and keep the pole 1 at the desired height. FIG. 4 also shows a wall bracket stabilizing mechanism. This includes a wall bracket collar 23 that may be rigidly attached to the pole 1 or moveable up and down the pole 1. The wall bracket collar 23 is attached to a wall bracket arm 24. This wall bracket arm 24 may be hinged or rotatably attached to the wall bracket collar 23 if necessary, for correct positioning on the wall 26. The wall bracket arm 24 connects the wall bracket collar 23 to a wall bracket 25. The wall bracket 25 may be connected to the wall 26 using mechanical means such as screws or bolts 28, for example.

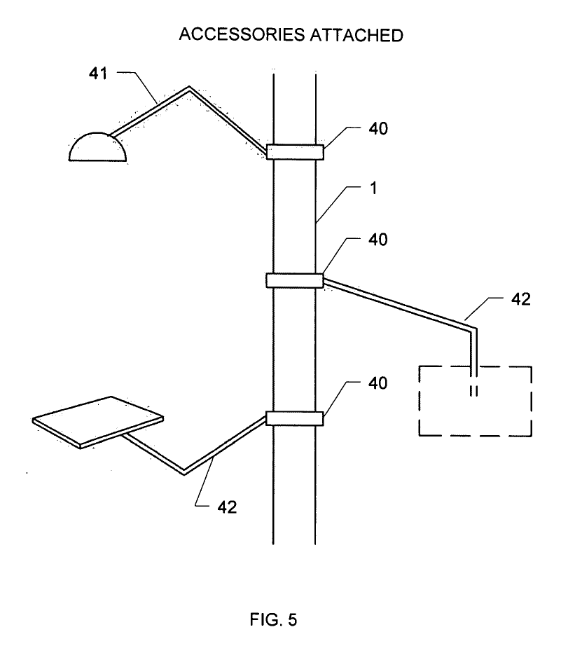

FIG. 5 shows the pole 1 with accessory collars 40 and arms 41 attached. These accessory collars 40 may be slidably attached to the pole 1, so that they can slide up and down the pole 1 and then be fixed in place using mechanical means, when the accessory height is where the user wishes. Attached to the accessory collar 40 is an accessory arm 41 that connects the accessory to the accessory collar 40. This arm 41 may be hingedly or rotatably attached to the collar 40 for more precise accessory positioning. This arm 41 may have an accessory arm elbow 42, which will add further adjustability to the accessory positioning.

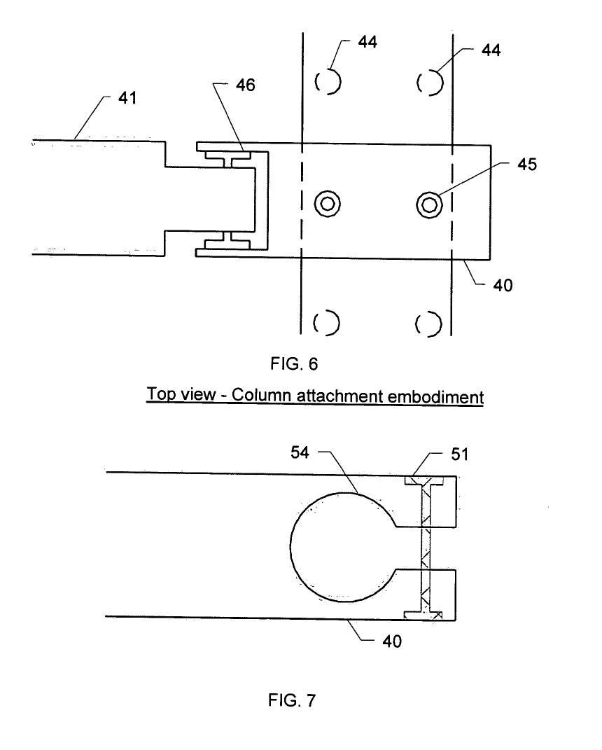

FIG. 6 shows an embodiment for the accessory collar 40 attachment and hinge. The height of accessory collar 40 may be positioned by sliding the collar 40 up or down the pole 1, while the bolts or screws 45 are loosened. On the pole 1 there are a series of holes or slots 44. Once the accessory arm 41 is positioned at the desired height, the screws or bolts 45 are inserted into the holes or slots 44. The hinge system consists of a simple bearing 46 that connects the arm 41 to the collar 40. An alternative to holes or slots 44 are vertical grooves in the surface of pole 1 to permit more options for adjustability in the height of the accessory arm.

FIG. 7 shows a top view of an alternative embodiment for an accessory collar 40 attachment mechanism. It includes a pole cavity 54 and accessory collar positioning bolt 51. The cavity 54 is a shape that will wrap around the utility station pole 1 and slide up and down easily. By loosening this bolt 51 the collar 40 can slide up or down to the desired height and then the bolt 51 can be tightened to keep the collar in the desired location.

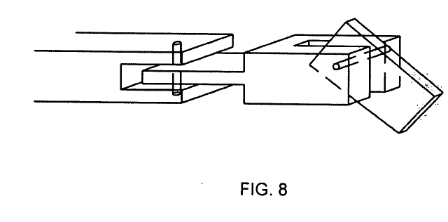

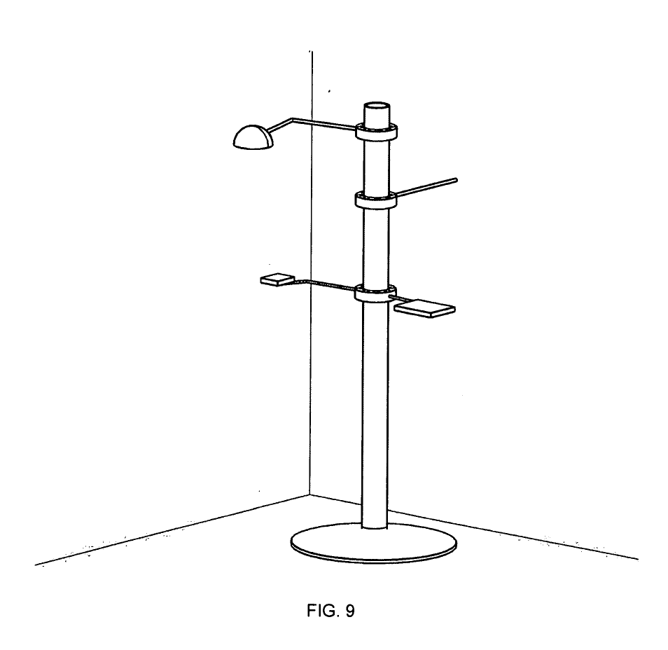

FIG. 8 shows an embodiment of a block joint for mobility of positioning of the arm. The joint shown shows a two-way block joint having a range of motion in a horizontal plane in addition to having a range of motion in a vertical plane.

FIG. 9 shows an alternative embodiment shown an alternative non-bolted base and additional retention system.

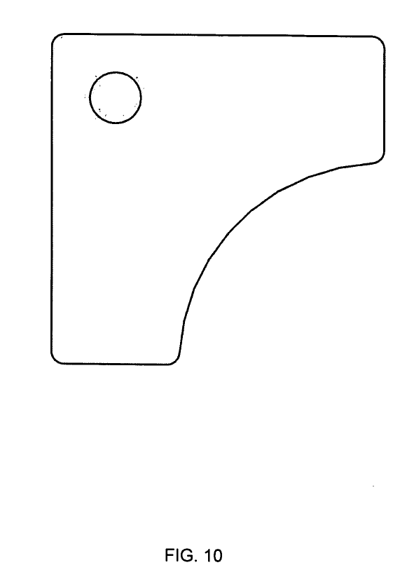

FIG. 10 shows the top view of a work space component having a hole near the corner to accommodate the vertical column.

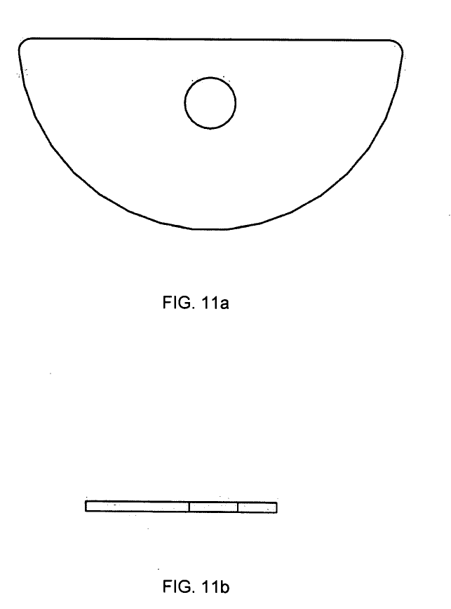

FIG. 11 shows the top and side views of a semi-circular work space component having a hole to accommodate the vertical column.

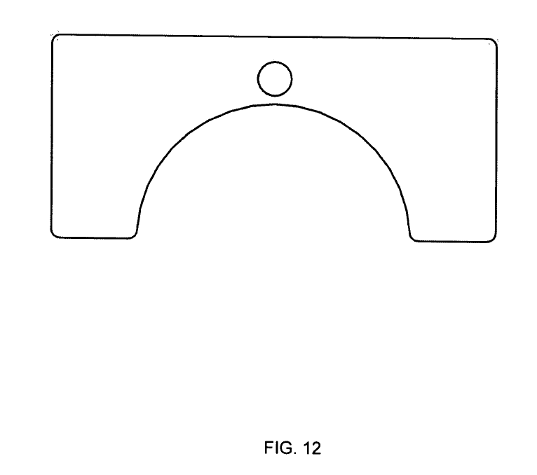

FIG. 12 shows the top view of a work space component having a semi-circular cut out for access by the user and a hole near the center to accommodate the vertical column.

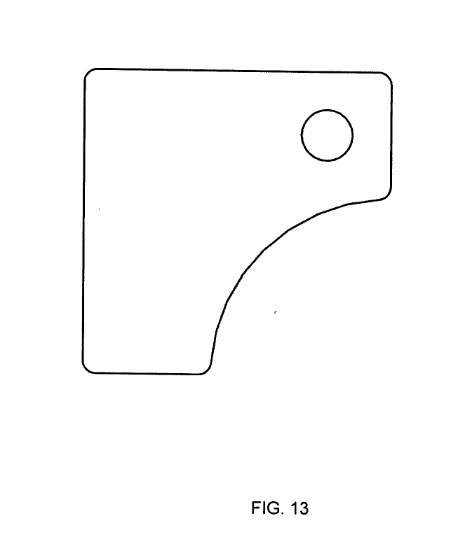

FIG. 13 shows the top view of a work space component having a quarter circular cut out and a hole near one end to accommodate the vertical column.

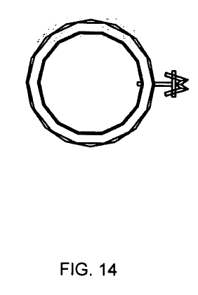

FIG. 14 shows a top view of a snap punch locking collar for encircling and attaching to the vertical column.

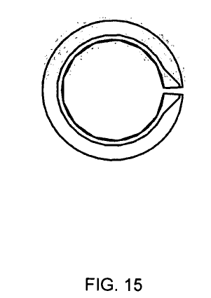

FIG. 15 shows a top view of a hex key locking collar for encircling and attaching to the vertical column.

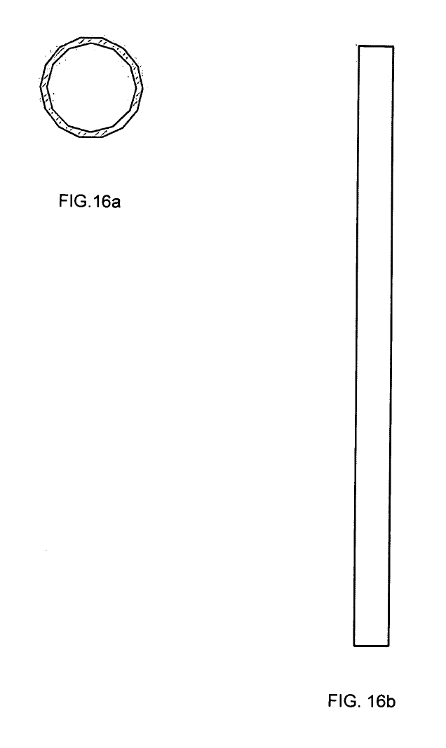

FIG. 16 is s side view of the chrome steel vertical column.

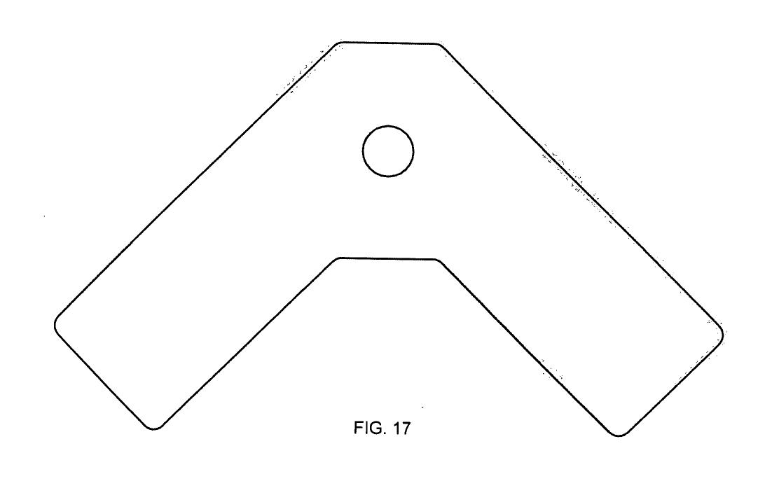

FIG. 17 shows a top view of a work space component showing a corner component having two sides and a hole near the center to accommodate the vertical column.

FIG. 18 shows the top view of a work space component having a semi-circular cut out for access by the user and a hole near one corner to accommodate the vertical column.

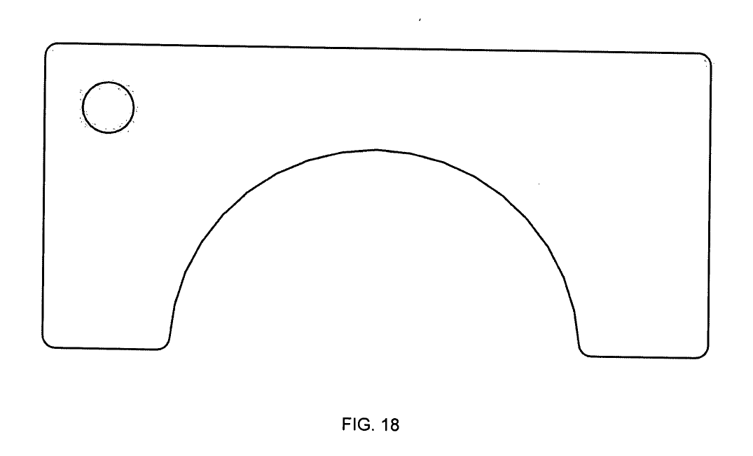

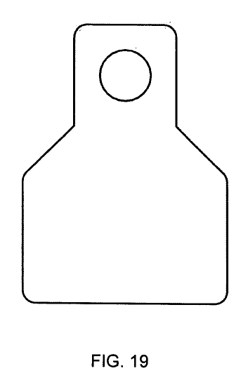

FIG. 19 shows a top view of a support platform base for supporting equipment and also showing a hole near the center to accommodate the vertical column.

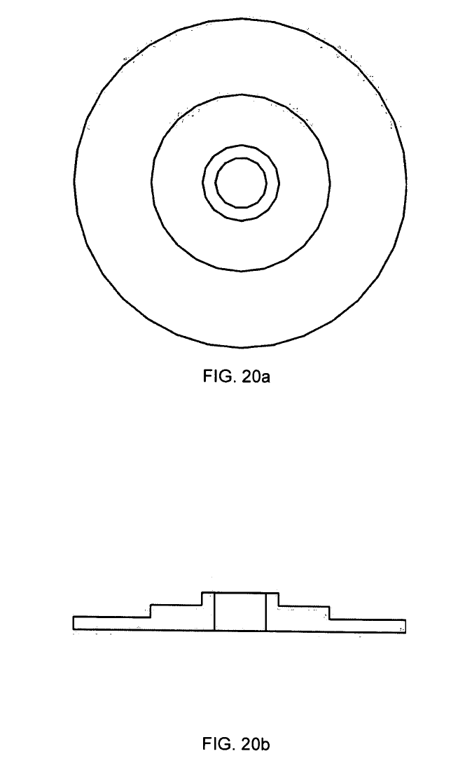

FIG. 20 shows the stepped ring column base. FIG. 20a is a top view thereof and FIG. 20b is a side view thereof.

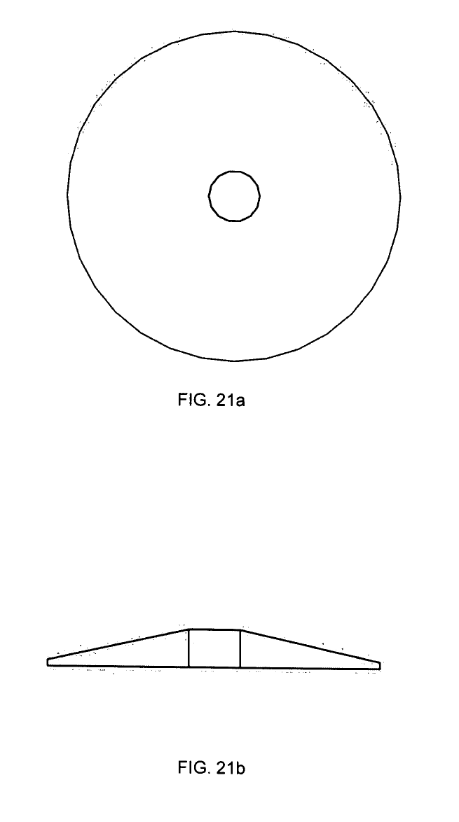

FIG. 21] shows the sloped top column base. FIG. 21a is a top view thereof and FIG. 21b is a side view thereof.

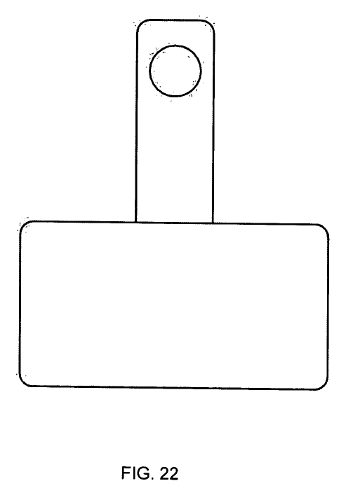

FIG. 22 is a top schematic view of an articulating foot rest showing a hole to accommodate the vertical column.

FIG. 23 is a top view of a horizontal collar for attaching to a horizontal work space component.

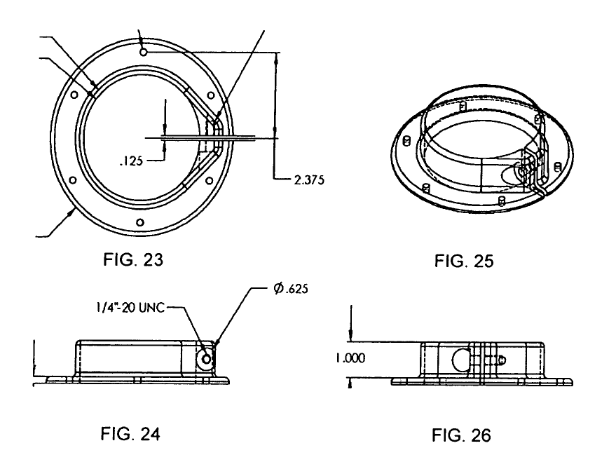

FIG. 24 is a side view of the horizontal collar of FIG. 23.

FIG. 25 is a top perspective view of the horizontal collar for attaching the horizontal work space component to the vertical column.

FIG. 26 is a side view of the collar of FIG. 25 showing the locking pin.

The collar shown in FIGS. 23 through 26 attach to horizontal work space components. The horizontal work space components are depicted in FIGS. 1, 10, 11, 12, 13, 17, 18, and 19. Horizontal work space components have a hole for receiving the vertical column. The collar of FIGS. 23 through 26 attach to the horizontal work space component surrounding the hole. The collar then fits around the vertical column and is secured by a locking pin.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A utility station pole assembly, said pole having a first end and a second end for management of components comprising;
an elongate pole with a base structure at the first end for engagement with a supporting surface and at least one accessory arm located on the pole;
attachment means to connect the accessory arm at the desired location along the pole;
and at least one component attached to said accessory arm for use as part of a utility station system; and
at least one horizontal work space component.

2. A utility station pole assembly as in claim 1 further comprising stabilization means for pole stabilization incorporated in the base structure.

3. A utility station pole assembly as in claim 1 wherein the supporting surface is the floor and the pole is vertical.

4. A utility station pole assembly as in claim 3 further comprising a light fixture.

5. A utility station pole assembly as in claim 1 further comprising at least one wall bracket mechanism consisting of a collar that is slidably attached to the pole, a bracket connected to said collar that projects radially from the pole and a plate connected to said bracket for mechanical attachment to a wall for pole stabilization.

6. A utility station pole assembly as in claim 5 wherein said bracket is hingedly attached to said collar.

7. A utility station pole assembly as in claim 5 wherein said bracket is rotatably attached to said collar.

8. A utility station pole assembly as in claim 5 wherein said bracket is rotatably attached to said plate.

9. A utility station pole assembly as in claim 1 wherein at least one accessory arm has a series of ball and socket joints located along the accessory arm for further accessory positioning.

10. A utility station pole assembly as in claim 1 further comprising at least one wiring clamp located on the pole for accessory wiring and communication cable management along the pole.

11. A utility station pole assembly as in claim 1 further comprising at least one wiring clamp located on at least one of the accessory arms for wiring and communication cable management from the accessory.

12. A utility station pole assembly as in claim 1 further comprising at least one electrically connected socket located on the pole for connection to an attached accessory.

13. A utility station pole assembly as in claim 12 wherein at least one electrically connected socket is electrically connected to a centrally located power strip on the pole at a desired location.

14. A utility station pole assembly of claim 1 wherein the horizontal work space component is attached to the pole by means of a horizontal collar.
